(19) United States
(12) Patent Application Publication
(10) Pub. No.: US 2008/0118060 A1
(43) Pub. Date: May 22, 2008

(54) Method of decoding/encoding content file

(75) Inventors: Myung-Sun Kim, Uiwang-si (KR); Hak-soo Ju, Suwon-si (KR); Ji-young Moon, Suwon-si (KR); Ju-hee Seo, Seoul (KR); Mi-hwa Park, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONCS CO., LTD., Suwon-si (KR)

(21) Appl. No.: 11/654,589

(22) Filed: Jan. 18, 2007

(30) Foreign Application Priority Data
Nov. 22, 2006 (KR) 10-2006-0116070

(51) Int. Cl. H04L 9/14; H04L 9/28

(52) U.S. Cl. 380/47; 380/28

(57) ABSTRACT

A method of decoding/encoding a content file is provided. The method of decoding a content file includes dividing an encoded content file into a plurality of data blocks, grouping the plurality of data blocks into a plurality of groups, generating a group content key for each of the plurality of groups, generating a plurality of block keys for the data blocks in each of the plurality of groups from the group content key generated for each of the plurality of groups, and decoding the plurality of data blocks using the plurality of block keys.

### CROSS-REFERENCE TO RELATED PATENT APPLICATION

This application claims priority from Korean Patent Application No. 10-2006-0116070, filed on Nov. 22, 2006, in the Korean Intellectual Property Office, the disclosure of which is incorporated herein in its entirety by reference.

### BACKGROUND OF THE INVENTION

1. Field of the Invention

Methods consistent with the present invention relate to decoding/encoding a contents file, and more particularly, to decoding/encoding content safely and rapidly on a digital rights management (DRM) system.

2. Description of the Related Art

With the wide spread of the Internet and advances in communication technologies, various digital contents are produced and processed for distribution. However, since unlike analog data, digital content can be losslessly copied and can be easily reused, processed, and distributed, it is prone to illicit copying.

In particular, digital content distribution environments are ever expanding due to combination between networks, combination between devices, and combination between contents and services. In other words, content could be distributed using a personal computer connected to the Internet in the past, but content can also be distributed using electronic appliances and mobile devices through digital broadcasting and home networking at present.

In order to protect content and content producers from illicit copying, research on digital rights management (DRM) have been actively conducted and various services using DRM have been introduced.

Namely, DRM is applied to content by encoding/decoding the content with a content key in order to restrict the use of the content.

FIG. 1 is a view for explaining a related art method for assigning a content key to data blocks of a content file.

Since a content file to which DRM is to be applied is generally voluminous, it is stored after being divided into a plurality of data blocks C₀, C₁, C₂, . . . , Cₜ as illustrated in FIG. 1 and then encoded. Each of the data blocks C₀, C₁, C₂, . . . , Cₜ includes content data, a header, and a binary execution code and may be implemented with various algorithms according to content.

As illustrated in FIG. 1, in Open Mobile Alliance (OMA) DRM, encoding/decoding are performed on all the data blocks C₀, C₁, C₂, . . . , Cₜ using a single content key Kc. In other words, all the data blocks C₀, C₁, C₂, . . . , Cₜ are encoded using the same content key Kc or an encoded content file is decoded using the same content key Kc.

However, when all the data blocks C₀, C₁, C₂, . . . , Cₜ are encoded/decoded using the same content key Kc as illustrated in FIG. 1, DRM for all the data blocks C₀, C₁, C₂, . . . , Cₜ is released and thus the content file may be used without any restriction if the content key Kc is revealed to others.

FIG. 2 is a view for explaining a related art method for assigning content keys to data blocks of a content file.

As illustrated in FIG. 2, in Windows media DRM (WMDRM), data blocks C₀, C₁, C₂, . . . , Cₜ are encoded/decoded using their assigned content keys K₀, K₁, K₂, . . . , Kₜ. In other words, each data block is encoded/decoded using its assigned content key.

However, when the data blocks C₀, C₁, C₂, . . . , Cₜ are encoded/decoded using their assigned content keys K₀, K₁, K₂, . . . , Kₜ as illustrated in FIG. 2, encoding/decoding has to be performed using an algorithm for extracting each of the content keys K₀, K₁, K₂, . . . , Kₜ for each of the data blocks C₀, C₁, C₂, . . . , Cₜ, causing a large amount of time to be spent in encoding/decoding.

### SUMMARY OF THE INVENTION

The present invention provides a method of decoding/encoding content with high security and at high speed when a DRM content file is encoded/decoded.

According to one aspect of the present invention, there is provided a method of decoding a content file. The method includes dividing an encoded content file into a plurality of data blocks, grouping the plurality of data blocks into a plurality of groups, generating a group content key for each of the plurality of groups, generating a plurality of block keys for the data blocks included in each of the groups from the group content key generated for the group, and decoding the plurality of data blocks using the plurality of block keys.

The method may further include grouping a plurality of data blocks included in each of the plurality of groups into a plurality of sub groups, generating a plurality of sub group content keys for each of the plurality of sub groups from the group content key generated for the group, and generating the plurality of block keys from the sub group content keys.

The plurality of sub group content keys may be simultaneously generated from the group content key and the plurality of block keys may be simultaneously generated from the sub group content keys.

The plurality of block keys may be used to simultaneously decode the plurality of data blocks.

The method may further include generating a first block key for decoding a first data block in the plurality of data in each of the plurality of groups blocks by inputting the group content key to a hash function.

The method may further include generating a second block key for decoding a second data block in the plurality of data blocks in each of the plurality of groups by inputting the first block key to the hash function.

The grouping of the data blocks into the plurality of groups may include determining a number of data blocks grouped into each of the groups according to a group size.

When the group content keys and the block keys are generated, license information may also be generated.

The plurality of block keys and the plurality of data blocks may be matched with each other on a one-to-one correspondence basis.

Digital rights management may be applied to the content file.

According to another aspect of the present invention, there is provided a method of encoding a content file. The method includes dividing a content file into a plurality of data blocks, grouping the plurality of data blocks into a plurality of groups, generating a group content key for each of the plurality of groups, generating a plurality of block keys for the data blocks included in each of the groups from the group content key generated for the group, and encoding the plurality of data blocks using the plurality of block keys.

According to another aspect of the present invention, there is provided a decoding module. The decoding module includes a content division unit dividing an encoded content file into a plurality of data blocks, a grouping unit grouping the plurality of data blocks into a plurality of groups, a content key generation unit generating a group content key for each of the plurality of groups, a block key generation unit generating a plurality of block keys for the data blocks included in each of the groups from the group content key generated for the group, and a decoding unit decoding the plurality of data blocks using the plurality of block keys.

According to another aspect of the present invention, there is provided an encoding module. The encoding module includes a content division unit dividing a content file into a plurality of data blocks, a grouping unit grouping the plurality of data blocks into a plurality of groups, a content key generation unit generating a group content key for each of the plurality of groups, a block key generation unit generating a plurality of block keys for the data blocks included in each of the groups from the group content key generated for the group, and an encoding unit encoding the plurality of data blocks using the plurality of block keys.

### BRIEF DESCRIPTION OF THE DRAWINGS

The above and other aspects of the present invention will become more apparent by describing in detail exemplary embodiments thereof with reference to the attached drawings in which:

FIG. 1 is a view for explaining a related art method for assigning a content key to data blocks of a content file;

FIG. 2 is a view for explaining a related art method for assigning content keys to data blocks of a content file;

FIG. 3 is a block diagram of an encoding/decoding module according to an exemplary embodiment of the present invention;

FIG. 4 is a flowchart illustrating a method of encoding a content file according to an exemplary embodiment of the present invention;

FIG. 5 is a view for explaining a method of assigning content keys to data blocks of a content file according to an exemplary embodiment of the present invention;

FIG. 6 is a view for explaining a method in which a block key generation unit according to an exemplary embodiment of the present invention generates block keys from a group content key; and

FIG. 7 is a view for explaining another method in which a block key generation unit according to an exemplary embodiment of the present invention generates block keys from a group content key.

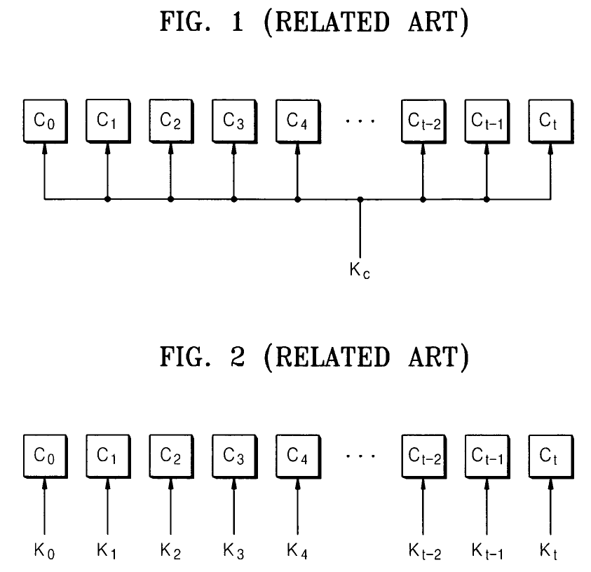

### DETAILED DESCRIPTION OF EXEMPLARY EMBODIMENTS OF THE INVENTION

Hereinafter, an exemplary embodiment of the present invention will be described in detail with reference to the accompanying drawings. Like reference numerals refer to like elements throughout the figures.

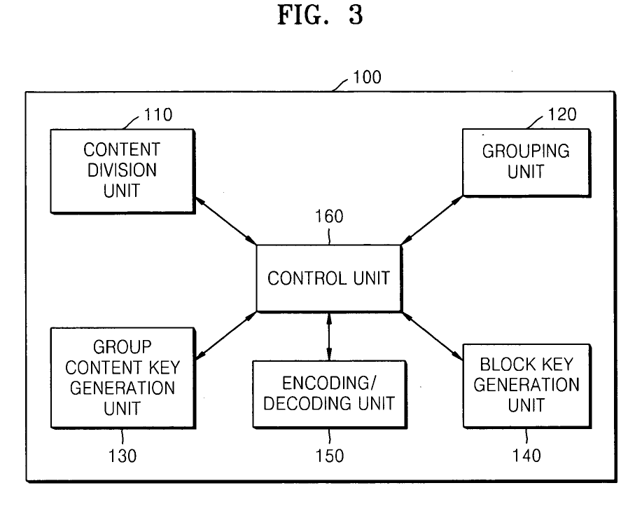

FIG. 3 is a block diagram of an encoding/decoding module 100 according to an exemplary embodiment of the present invention.

The encoding/decoding module 100 includes a content division unit 110, a grouping unit 120, a group content key generation unit 130, a block key generation unit 140, an encoding/decoding unit 150, and a control unit 160.

The content division unit 110 divides a content file into a plurality of data blocks of a encoding unit size of m.

The grouping unit 120 groups the divided plurality of data blocks according to a group size of n, i.e., clusters the divided plurality of data blocks into groups according to the group size n.

The group content key generation unit 130 generates a group content key Kg for each of the groups and assigns the generated group content key Kg and license information to the group.

The block key generation unit 140 generates a block key Kc for each of the data blocks included in the group from the group content key Kg and assigns the generated block key Kc and the license information to the data block.

The encoding/decoding unit 150 encodes or decodes content data stored in the data block using the block key Kc assigned to the data block.

During encoding using the block key Kc, the encoding/decoding unit 150 encodes required information including a header of the entire content, a header of group content, and a header of content data of the data block.

During decoding, the encoding/decoding unit 150 induced the group content key Kg for each of the groups using the required information including the header of the entire content, the header of group content, and the header of content data of each data block, transmits the induced group content key Kg to the block key generation unit 140, and generates the block keys Kc from the group content key Kg.

The control unit 160 controls an overall process in relation to the content division unit 110, the grouping unit 120, the group content key generation unit 130, the block key generation unit 140, and the encoding/decoding unit 150.

Although the encoding/decoding unit 150 is included in the encoding/decoding module 100 for convenience of explanation in an exemplary embodiment of the present invention, an encoding unit and a decoding unit may be included in an encoding module and a decoding module, respectively.

Hereinafter, encoding performed by the encoding/decoding module 100 according to an exemplary embodiment of the present invention will be described.

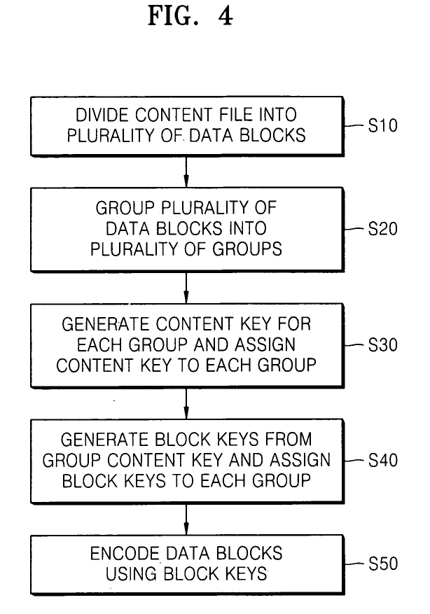

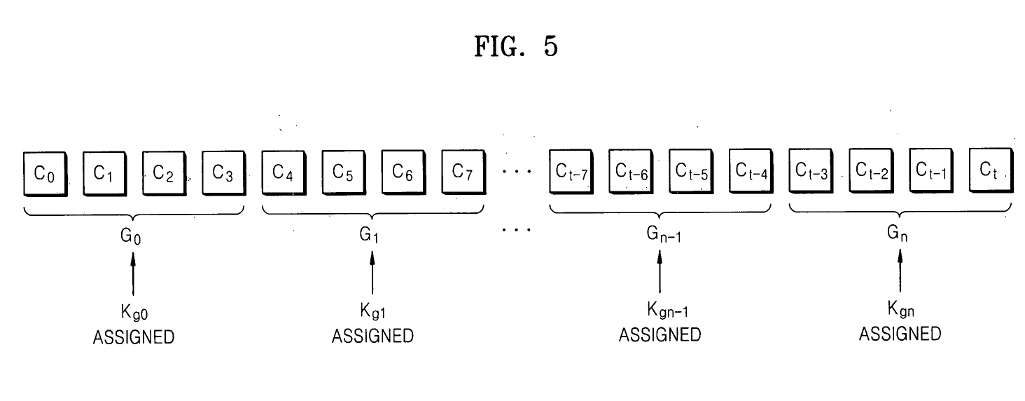

FIG. 4 is a flowchart illustrating a method of encoding a content file according to an exemplary embodiment of the present invention, and FIG. 5 is a view for explaining a method of assigning content keys (Kc) to data blocks of a content file according to an exemplary embodiment of the present invention.

As illustrated in FIG. 4, a content file is stored after being divided into a plurality of data blocks of a encoding unit size of m in operation S10.

In other words, as illustrated in FIG. 5, the content division unit 110 divides the content file into a plurality of data blocks C₀, C₁, C₂, . . . , Cₜ according to the encoding unit size m.

The divided data blocks are grouped into a plurality of groups in operation S20.

In other words, as illustrated in FIG. 5, the grouping unit 120 groups the plurality of data blocks C₀, C₁, C₂, . . . , Cₜ into groups G₀, G₁, G₂, . . . , Gₙ. For example, the group Go includes a plurality of data blocks C₀, C₁, C₂, and C₃, and the group G₁ includes a plurality of data blocks C₄, C₅, C₆, and C₇. It is not necessary to group four data blocks into one group as illustrated in FIG. 5 and the number of data blocks included in one group may be determined according to the group size n that is set by the grouping unit 120.

After grouping is finished, the group content key Kg for each of the groups is generated and assigned to the group in operation S30.

In other words, as illustrated in FIG. 5, the group content key generation unit 130 generates group content keys Kg₀, Kg₁, Kg₂, . . . , Kgₙ for the groups G₀, G₁, G₂, . . . , Gₙ and assigns the group content keys Kg₀, Kg₁, Kg₂, . . . , Kgₙ to the groups G₀, G₁, G₂, . . . , Gₙ, respectively.

After the group content key Kg for each of the groups is generated and assigned to the group, the block key Kc for each of the data blocks included in the group is generated and assigned to the data block in operation S40.

In other words, the block key generation unit 140 generates the block key Kc for each of the data blocks included in each group from the group content key Kg assigned to the group and assigns the block key Kc to the data block.

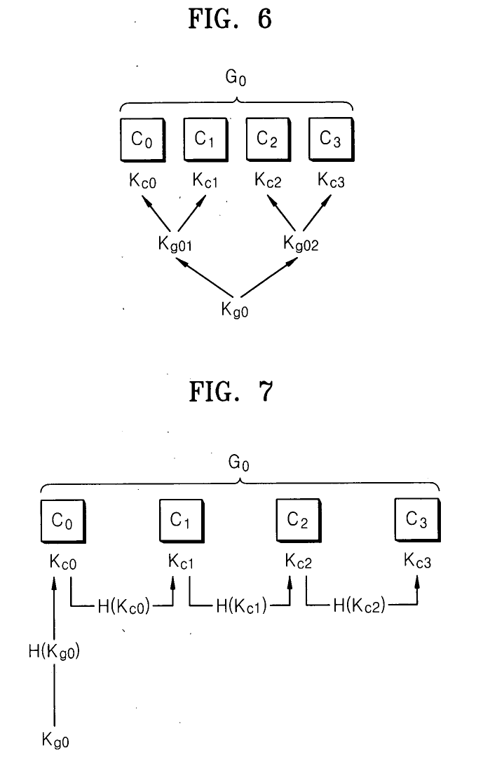

For example, for the group G₀, block keys Kc₀, Kc₁, Kc₂, and Kc₃ for encoding the data blocks C₀, C₁, C₂, and C₃ are generated from the group content key Kg₀ and are assigned to the data blocks C₀, C₁, C₂, and C₃. A method of generating the block keys Kc from the group content key Kg will be described later in more detail with reference to FIGS. 6 and 7.

Once assignment of the block keys Kc is finished, each of the data blocks included in each of the groups is encoded using the generated block key Kc in operation S50. In other words, the encoding/decoding unit 150 encodes content data corresponding to each of the data blocks using the block key Kc assigned to the data block.

Since decoding is performed in a similar manner to encoding, repetitive explanation will be avoided. Also, a method of generating the block keys Kc from the group content key Kg can be easily implemented by those skilled in the art and thus will not be described.

FIG. 6 is a view for explaining a method in which the block key generation unit 140 according to an exemplary embodiment of the present invention generates the block keys Kc from the group content key Kg.

For convenience of explanation, a state where the block keys Kc₀, Kc₁, Kc₂, and Kc₃ for encoding the data blocks C₀, C₁, C₂, and C₃ are generated from the group content key Kg₀ will be taken as an example.

As illustrated in FIG. 6, the block key generation unit 140 generates a sub group content key Kg₀₁ and a sub group content key Kg₀₂ corresponding to sub groups using the group content key Kg₀. The block keys Kc₀ and Kc₁ may be induced from the sub group content key Kg₀₁ and the block keys Kc₂ and Kc₃ may be induced from the sub group content key Kg₀₂.

By using the sub group content key corresponding to an intermediate level between the group content key and the block key, the amount of time required to generate the block key can be reduced.

In other words, since the block keys Kc₀, Kc1, Kc2, and Kc3 are simultaneously induced from the sub group content keys Kg01 and Kg02 that is generated from the group content key Kg0, the time required for generating the block keys K_{c0}, K_{c1}, K_{c2}, and K_{c3} is the same as the time required for generating two block keys from a group content key.

In other words, the time required for generating block keys from a group content key is proportional to the number of content key levels included in a group. Therefore, as the number of pieces of content data included in a group increases, more time can be saved in generating block keys.

Thus, all the block keys included in a group can be generated for a time period that is shorter than a time period required for generating the block keys separately for data blocks included in the group from a group content key, and the encoding/decoding unit 150 encodes the data blocks using the generated block keys.

A process of decoding encoded data blocks is similar to a process of encoding the data blocks.

In other words, the block key generation unit 140 generates the sub group content key Kg₀₁ and the sub group content key Kg₀₂ corresponding to sub groups using the group content key Kg₀. The block keys Kc₀ and Kc₁ may be induced from the sub group content key Kg₀₁ and the block keys Kc₂ and Kc₃ may be induced from the sub group content key Kg₀₂. The block keys Kc₀, Kc₁, Kc₂, and Kc₃ may be used to decode the data blocks C₀, C₁, C₂, and C₃.

During decoding, like an encoding process, the block keys Kc₀, Kc₁, Kc₂, and Kc₃ are simultaneously generated from the sub group content keys Kg₀₁ and Kg₀₂ that are generated from the group content key Kg₀, thereby reducing the time required for generating the block keys Kc₀, Kc₁, Kc₂, and Kc₃ when compared to the time required for generating the block keys Kc₀, Kc₁, Kc₂, and Kc₃ separately for the data blocks C₀, C₁, C₂, and C₃ included in the group G₀ from the group content key Kg₀.

As such, the time required for encoding or decoding content data can be reduced by the method for block key generation illustrated in FIG. 6.

FIG. 7 is a view for explaining another method in which the block key generation unit 140 according to an exemplary embodiment of the present invention generates the block keys Kc from the group content key Kg.

Like in FIG. 6, a case where the block keys Kc₀, Kc₁, Kc₂, and Kc₃ for encoding the data blocks C₀, C₁, C₂, and C₃ are generated from the group content key Kg₀ will be taken as an example for convenience of explanation.

As illustrated in FIG. 7, the block key generation unit 140 applies a hash function to the group content key Kg₀ in order to generate the block key Kc₀ and applies the hash function to the block key Kc₀ in order to generate the block key Kc₁.

The block key generation unit 140 also applies the hash function to the generated block key Kc₁ in order to generate the block key Kc₂ and applies the hash function to the generated block key Kc₂ in order to generate the block key Kc₃.

In other words, using a given hash table, the block key generation unit 140 matches the content key Kg₀ with the block key Kc₀ in order to output the block key Kc₀ when the group content key Kg₀ is input to the hash function and matches the block key Kc₀ with the block key Kc₁ in order to output the block key Kc₁ when the block key Kc₀ is input to the hash function. Similarly, the block key generation unit 140 matches the block key Kc₁ with the block key Kc₂ in order to output the block key Kc₂ when the block key Kc₁ is input to the hash function and matches the block key Kc₂ with the block key Kc₃ in order to output the block key Kc₃ when the block key Kc₂ is input to the hash function.

More specifically, the block key generation unit 140 substitutes the group content key Kg₀ into a hash function H in order to search for and generate the block key Kc₀ corresponding to content data C₀, as follows:

Kc₀=H(Kg₀) (1)

The block key generation unit 140 substitutes the generated block key Kc₀ into a hash function H in order to search for and generate the block key Kc₁ corresponding to content data C₁, as follows:

Kc₁=H(Kc₀)=H(H(Kg₀)) (2)

In this way, the block key generation unit 140 generates block keys for consecutive pieces of content data using the hash function H.

Thus, when the number of pieces of content data included in a group is n, the block key generation unit 140 generates a block key Kcₙ for a data block Cₙ as follows:

Kcₙ=H(Kcₙ₋₁)=Hⁿ⁺¹(Kg₀) (3)

In this way, the block key generation unit 140 can generate all the block keys Kc₀, Kc₁, Kc₂, and Kc₃ for the data blocks C₀, C₁, C₂, and C₃ included in the group G₀ from the single group content key Kg₀ by connecting the hash function H like a chain. Thus, if one of a plurality of block keys is not generated, the next block key cannot be generated either, thereby strengthen security.

Moreover, since the time required for searching for a block key is reduced by using a hash function, the block key can be generated at high speed and the encoding/decoding unit 150 encodes a corresponding data block using the generated block key.

A process of decoding an encoded data block is similar to a process of encoding the data block.

In other words, the encoding/decoding unit 150 applies the hash function to the group content key Kg₀ in order to generate the block key Kc₀ and applies the hash function to the block key Kc₀ in order to generate the block key Kc₁.

The encoding/decoding unit 150 applies the hash function to the block key Kc₁ in order to generate the block key Kc₂ and applies the hash function to the block key Kc₂ in order to generate the block key Kc₃.

As such, during decoding, like the encoding process, it is possible to reduce the time required for generating a block key and strengthen security by using a hash function.

A method of encoding and decoding a content file before execution of a program and a method of encoding and decoding a content file during execution of a program according to the present invention can also be embodied as a computer-readable code. Codes and code segments for the program can be easily construed by computer programmers skilled in the art. The program is stored in computer-readable media and then read and executed by a computer, thereby implementing the method of encoding and decoding a content file. Examples of the computer-readable media include magnetic recording media, and optical recording media.

As described above, according to the present invention, a content file is encoded/decoded after being divided into a plurality of data blocks, thereby strengthen security and increasing the speed of encoding or decoding the content file.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of decoding a content file, the method comprising:
dividing an encoded content file into a plurality of data blocks;
grouping the plurality of data blocks into a plurality of groups;
generating a group content key for each of the plurality of groups;
generating a plurality of block keys for the data blocks in each of the plurality of groups from the group content key generated for each of the plurality of groups; and
decoding the plurality of data blocks using the plurality of block keys.

2. The method of claim 1, further comprising:
grouping a plurality of data blocks in each of the plurality of groups into a plurality of sub groups;
generating a plurality of sub group content keys for each of the plurality of sub groups from the group content key generated for each of the plurality of groups; and
generating the plurality of block keys from the sub group content keys.

3. The method of claim 2, wherein the plurality of sub group content keys are simultaneously generated from the group content key and the plurality of block keys are simultaneously generated from the plurality of the sub group content keys.

4. The method of claim 3, wherein the plurality of block keys are used to simultaneously decode the plurality of data blocks.

5. The method of claim 1, wherein the generating of the plurality of block keys comprises generating a first block key for decoding a first data block of the plurality of data blocks by inputting the group content key to a hash function.

6. The method of claim 5, wherein the generating the plurality of block keys further comprises generating a second block key for decoding a second data block of the plurality of data blocks by inputting the first block key to the hash function.

7. The method of claim 1, wherein the grouping of the data blocks into the plurality of groups comprise determining a number of data blocks grouped into each of the plurality of groups according to a group size.

8. The method of claim 1, wherein when the group content keys and the block keys are generated, license information is also generated.

9. The method of claim 1, wherein the plurality of block keys and the plurality of data blocks are matched with each other on a one-to-one correspondence basis.

10. The method of claim 1, wherein digital rights management is applied to the content file.

11. A method of encoding a content file, the method comprising:
dividing a content file into a plurality of data blocks;
grouping the plurality of data blocks into a plurality of groups;
generating a group content key for each of the plurality of groups;
generating a plurality of block keys for the data blocks in each of the plurality of groups from the group content key generated for each of the plurality of groups; and
encoding the plurality of data blocks using the plurality of block keys.

12. The method of claim 1 1, further comprising:
grouping a plurality of data blocks in each of the plurality of groups into a plurality of sub groups;
generating a plurality of sub group content keys for each of the plurality of sub groups from the group content key generated for each of the plurality of groups; and
generating the plurality of block keys from the plurality of sub group content keys.

13. The method of claim 12, wherein the plurality of sub group content keys are simultaneously generated from the group content key and the plurality of block keys are simultaneously generated from the plurality of sub group content keys.

14. The method of claim 13, wherein the plurality of block keys are used to simultaneously encode the plurality of data blocks.

15. The method of claim 11, wherein the generating the plurality of block keys comprises generating a first block key for encoding a first data block of the plurality of data blocks by inputting the group content key to a hash function.

16. The method of claim 15, wherein the generating the plurality of block keys further comprises generating a second block key for encoding a second data block of the plurality of data blocks by inputting the first block key to the hash function.

17. A decoding module comprising:
a content division unit which divides an encoded content file into a plurality of data blocks;
a grouping unit which groups the plurality of data blocks into a plurality of groups;
a content key generation unit which generates a group content key for each of the plurality of groups;
a block key generation unit which generates a plurality of block keys for the data blocks in each of each of the plurality of groups from the group content key generated for the group; and
a decoding unit which decodes the plurality of data blocks using the plurality of block keys.

18. The decoding module of claim 17, wherein the grouping unit groups a plurality of data blocks in each of the plurality of groups into a plurality of sub groups, the group content key generation unit generates a plurality of sub group content keys for each of the plurality of sub groups from the group content key generated for each of the plurality of groups, and the block key generation unit generates the plurality of block keys from the plurality of sub group content keys.

19. The decoding module of claim 17, wherein the block key generation unit generates a first block key for decoding a first data block of the plurality of data blocks by inputting the group content key to a hash function.

20. The decoding module of claim 19, wherein the block key generation unit generates a second block key for decoding a second data block of the plurality of data blocks by inputting the first block key to the hash function.

21. An encoding module comprising:
a content division unit which divides a content file into a plurality of data blocks;
a grouping unit which groups the plurality of data blocks into a plurality of groups;
a content key generation unit which generates a group content key for each of the plurality of groups;
a block key generation unit which generates a plurality of block keys for the data blocks in each of each of the plurality of groups from the group content key generated for the group; and
an encoding unit which encodes the plurality of data blocks using the plurality of block keys.

22. The encoding module of claim 21, wherein the grouping unit groups a plurality of data blocks in each of the plurality of groups into a plurality of sub groups, the group content key generation unit generates a plurality of sub group content keys for each of the plurality of sub groups from the group content key generated for each of the plurality of groups, and the block key generation unit generates the plurality of block keys from the plurality of sub group content keys.

23. The encoding module of claim 21, wherein the block key generation unit generates a first block key for encoding a first data block of the plurality of data blocks by inputting the group content key to a hash function.

24. The encoding module of claim 23, wherein the block key generation unit generates a second block key for encoding a second data block of the plurality of data blocks by inputting the first block key to the hash function.

25. A computer-readable recording medium having recorded thereon a program for implementing the method of decoding an encoded content file and the method of encoding a content file claimed in claim 1.
